(19) United States
(12) Patent Application Publication
(10) Pub. No.: US 2016/0077230 A1
(43) Pub. Date: Mar. 17, 2016

(54) Presenting Information from Multiple Sensors

(71) Applicant: HEWLETT-PACKARD DEVELOPMENT COMPANY, L.P., Houston, TX (US)

(72) Inventors: RAVIGOPAL VENNELAKANTI, PALO ALTO, CA (US); SANGAMESH BELLAD, PALO ALTO, CA (US); PRASUN SINGH, PALO ALTO, CA (US); ANIL DEV V, BANGALORE (IN)

(21) Appl. No.: 14/763,097

(22) PCT Filed: Jan. 29, 2013
(86) PCT No.: PCT/US13/23679

§ 371 Date: Jul. 23, 2015

(51) Int. Cl. G01V 1/34

(52) U.S. Cl. CPC G01V 1/34; G01V 2210/72

(57) ABSTRACT

Presenting information from multiple sensors includes obtaining data points from multiple sensors in a geophysical survey, analyzing the data points to create multiple presentations derived from the data points about said geophysical survey, and switching from displaying one of the multiple presentations to another of the multiple presentations as commanded with user input.

### BACKGROUND

Seismic surveys are used to determine whether a subterranean formation has oil, gas, or other extractable natural resources. Such surveys are also used to determine how to extract such natural resources. A seismic survey conducted over dry land usually includes positioning between 100,000 and 200,000 geophones across the surface of an area superjacent the subterranean formation of interest. The geophones are hardwired together. Either natural or induced acoustic vibrations that pass through the subterranean formation are recorded with the geophones. The time of flight from induced acoustic vibrations and other acoustic characteristics are used to determine if the subterranean formation has a structure that is likely to contain the natural resource of interest and, if so, an extraction plan based on the subterranean formation's structure is developed to extract the natural resource.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of an area with wireless sensors deposited throughout according to the principles described herein.

FIG. 2 is a diagram of an example of a data point presentation according to the principles described herein.

FIG. 3 is a diagram of an example of an anomaly presentation according to the principles described herein.

FIG. 4 is a diagram of an example of an interpretative presentation according to the principles described herein.

FIG. 5 is a diagram of an example of a response presentation according to the principles described herein.

FIG. 6 is a diagram of an example of a presentation system's architecture according to the principles described herein.

FIG. 7 is a diagram of an example of a method for presenting information from multiple sensors according to the principles described herein.

FIG. 8 is a diagram of an example of a presentation system according to the principles described herein.

FIG. 9 is a diagram of an example of a presentation system according to the principles described herein.

FIG. 10 is a diagram of an example of a flowchart of a process for presenting information from multiple sensors according to the principles described herein.

### DETAILED DESCRIPTION

Geophones are wired devices used in seismic surveys for recording seismic data in real time, but they have limitations due to the scalability of such wired systems. The principles described herein incorporate the use of wireless sensors in seismic surveys that are capable of sending sensor health and seismic data quality information to a presentation system in near real time. Such sensors may send their sensor health and seismic data quality information to the presentation system on a periodic basis that is less than one minute (e.g. twenty seconds). Such information can be used to determine how the equipment for conducting the seismic survey is operating, determine how third party tools used in conjunction with surveying equipment are operating, and determine the quality of the seismic data being recorded. Such information can save time and resources. For example, if the recorded information indicates that a portion of the wireless sensors are not operating, third party tools for inducing the acoustic vibrations in the subterranean formation can be prevented from activating until all of the wireless sensors are operable.

Further, the principles described herein include incorporating over a million wireless sensors in the seismic survey, a significant increase over the traditional seismic surveys. Using recorded data points from over a million sensors every twenty seconds to make real time decisions is overwhelming for an operator of the seismic survey.

The principles described herein include a method for presenting information from multiple sensors. Such a method includes obtaining system health and seismic data quality from multiple sensors, analyzing the data points to create multiple presentations derived from the data points, and switching from displaying one of the multiple presentations to another of the multiple presentations as commanded with user input. Each of the presentations breaks down the information into different levels of analysis depending on the user's amount of interest. For example, one of the presentations is dedicated to displaying the system health recorded from the sensors, while another presentation identifies the anomalies from the seismic data quality. Yet another presentation interprets the information about the anomalies and identifies the issues indicative of such anomalies, while yet another presentation merely displays a response that the user should execute in response to the anomalies. The user may switch between these presentations as desired to gather the amount of information desired to make decisions.

Such a system allows a user to determine and react quickly to situations about conducting the seismic survey. For example, a user may prefer to have the presentation system set to display the interpretative presentation that identifies those issues indicative of the anomalies found in the data points. Once an issue is discovered that the user desires to investigate, the user can have the presentation system display just the information relevant to the anomaly or have the presentation system just indicates what remedial action(s) should be taken. The presentation system allows the user to switch between the presentations according to the user's level of interest when making a decision. Other users may prefer to have the default presentation at a different level of analysis and to switch between different presentations when making decisions.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

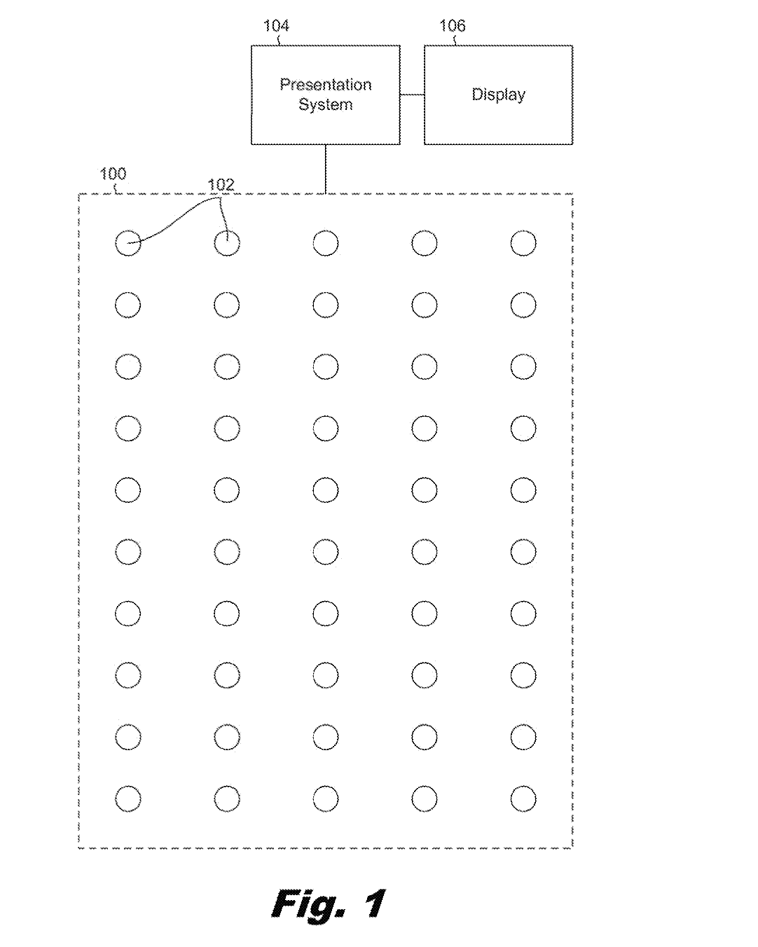

FIG. 1 is a diagram of an example of an area (100) with wireless sensors (102) deposited throughout the area (100) according to the principles described herein. In this example, the area (100) is superjacent a subterranean formation, and multiple wireless sensors (102) are deposited throughout the area (100). Each of the sensors records geophysical data about the subterranean formation such as acoustic information. For example, a tool may induce a vibration into the subterranean formation and the acoustic signals reflected by the subterranean formation from such induced vibrations are recorded with the sensors (102).

The tool for inducing the vibrations may be activated on the surface proximate the area (100), on the surface within the area (100), in a drilled hole near the subterranean formation of interest, in a drilled hole within the subterranean formation of interest, underground, other locations, or combinations thereof. Tools for inducing the vibrations include explosives, thumper trucks, hammers, other acoustic sources, or combinations thereof. Also, the sensors (102) may record other geophysical data, such as temperature, error codes, tilt, other geophysical characteristics, or combinations thereof. The sensors may also measure gravity, electrical characteristics of the subterranean formation, magnetic properties of the subterranean formation, other characteristics of the subterranean formation, or combinations thereof.

While the example of FIG. 1 is described with reference to wireless sensors deposited throughout an area, the principles described herein include sensors that are deposited in down-hole locations, hard wired sensors, sensors deposited on a surface, sensors deposited in machinery or other equipment, other locations or conditions, or combinations thereof. For example, the sensors may be incorporated into a data center, oil field infrastructure, off shore drilling platforms, factories, buildings, networks, aircraft, vehicles, vehicle fleets, surveillance equipment, global positioning units, mobile devices, other locations, other devices, other systems, or combinations thereof.

A presentation system (104) obtains data from the sensors (102) wirelessly. The sensor quality data may be automatically sent to the presentation system (104) on a periodic basis. The periodic basis may be five minutes or less, every minute or less, every half minute or less, every twenty seconds or less, every ten seconds or less, other time periods, or combinations thereof. In other examples, the presentation system (104) requests the data from the sensors (102), and the sensors (102) send the data to the presentation system (104) in response to the presentation system's request.

Any appropriate type of information may be obtained by the presentation system (104) from the sensors (102). For example, geophysical data, signal strengths, maximum signal amplitudes, minimum signal amplitudes, averages, compressed signals, processed data, repetitive data, raw data, operational data, battery data, bandwidth data, interference data, thermal data, processing data, memory data, other types of data, or combinations thereof may be used in accordance with the principles described herein.

For example, the data may provide an update on the system status of the sensors or other devices deployed for conducting the survey. The data may also include seismic characteristics such as the signal's root mean square, values peak amplitudes, other characteristics, or combinations thereof to detect the energy (signal to noise ratio) in the field. Both system and seismic data may amount to over fifty megabytes for each report sent on a periodic basis. The data obtained with the presentation system (104) may also include trace data aimed at probing target receiver sensor lines that have thousands of sensor trace data to create stacked traces.

The data may also include metrics either captured or derived to control and monitor operational aspects of the survey, such as deployment of sensors, retrieval of sensors, provisioning of sensors, charging of sensors, other aspects, or combinations thereof. Such operational aspects can include over a hundred and fifty attributes of the survey process model. Interdependencies between sub-systems and relationships between various metrics cannot be considered in isolation. The principles described herein provide the ability to make operational decisions and to determine whether to perform an operation, such as a seismic survey, within predetermined time periods.

In response to obtaining the data points from the sensors (102) and data from other sub systems such as a source controller, vehicle management system, and so forth, the presentation system (104) analyzes the data points and creates at least one presentation. Each of the presentations is generated to assist users of the system to make decisions. In some cases, the user merely relies on the system's recommended responses to issues. But, in other cases, the user drills down deeper to use more information to make decisions by viewing the other presentations. The amount of information provided to the user in real time is more than a human can process to make every decision in real time. The presentations provide the user with different levels of analysis to match the amount of interest the user has in making his decisions. For example, the user may be just interested in executing the recommendations made by the system. In other examples, the user consults the presentation system's basis for making the recommendation without having to analyze the entire data set from scratch. Thus, the presentation system (104) provides the user with a presentation that displays just the relevant information for the recommended response. In yet other examples, the user drills down even farther into the details of the information obtained with the presentation system (104) before making his decision. Thus, the presentation system (104) provides the user with various levels of analysis ranging in a continuum of detailed presentations to summary presentations as desired by the user.

The presentation system (104) is in communication with a display (106) that is capable of displaying and switching between the generated presentations based on the obtained data points. The presentation system (104) has a user interface to receive commands from the user to determine which of the presentations the user desires to see. The display (106) may be in hard wired communication with the presentation system (104), in wireless communication with the presentation system (104), or combinations thereof. The display (106) may be a mobile display that is incorporated into a phone, electronic tablet, laptop, other mobile device, or combinations thereof. In other examples, the display (106) is incorporated into a fixed location where the user makes decisions. The fixed location may be an onsite location proximate to the area, a remote location in satellite communication with the area, another location, or combinations thereof.

The display may be an interactive display (106) that allows the user to interact with the information presented in the display (106). The user can command the display (106) to switch from one presentation to another presentation by providing user input. For example, the user can command the presentations to switch though a key board input, a voice recognition input, a touch screen input, an auditory input, a motion detectable hand gesture input, another type of input, or combinations thereof.

The presentation system (104) may generate any appropriate type of presentation. For example, the presentation system (104) may generate a data point presentation that displays just the obtained data points, an anomaly presentation that displays data points indicative of anomalous behavior, an interpretative display that includes interpretations of what the data points indicative of anomalous behavior indicate, a response presentation that includes recommendations on how to respond to the anomalous behavior, other presentations, or combinations thereof. While the examples described herein are described with reference to specific numbers of presentations and types of presentations, any appropriate number or type of presentation may be used in accordance with the principles described herein.

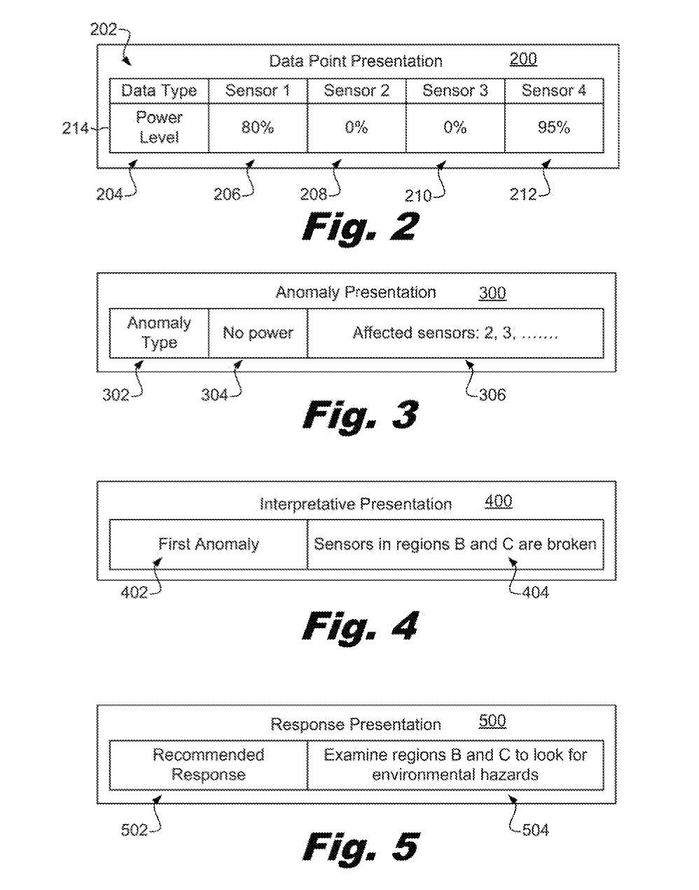

FIG. 2 is a diagram of an example of a data point presentation (200) according to the principles described herein. The data point presentation (200) includes measurements of at least one data type obtained from the sensors. In this example, a single data type (202), which is the battery level (204) of the sensors, is displayed. While this example is described with reference to a specific number of data types, any appropriate number of data types may be included in the data point presentation (200). For example, multiple different data types (202) may be displayed simultaneously in the data point presentation (200).

Further, while this example is described with reference to a specific data type (202), any appropriate data type (202) may be displayed in the data point presentation (200) according to the principles described herein. For example, the data point presentation (200) may include sensor power data, seismic data, bandwidth data, signal data, reception strength data, other data, or combinations thereof.

In other examples, the presentation system includes multiple data point presentations (200) where each data point presentation (200) is dedicated to a specific data type, to specific data types, to specific sensors, or combinations thereof. In such an example, the user has the ability to switch between the different data point presentations (200). In yet another example, the presentation system has dedicated data point presentations and a summary data point presentation that gives an overview of the data points.

The data points are displayed in any appropriate manner. For example, the data points may be displayed in a column and row format, a visual format, a color format, a symbolic format, an alphanumeric format, other format, or combinations thereof.

In this example, the power levels (204) of the sensors are displayed in a column and row format. Each of the columns (206, 208, 210, 212) identifies a sensor, and the single row (214) identifies the data type. The data points report that the first sensor and the fourth sensor have a power level of eighty percent and ninety five percent respectively. However, the data points report that the second sensor and the third sensor have a power level of zero percent. Data points that indicate that a sensor is registering zero percent power likely indicate an issue. However, the data point presentation does not highlight such an issue or anomaly. The other presentations focus in on such anomalies, interpret such anomalies, and make recommendations for responding to such anomalies.

The user may have an option to view historical data recorded by each of the sensors, subset of sensors, subset of data types, or combinations thereof in the data point presentation (200). In some examples, the data point presentation has an ability to display the historical data points over time. Thus, the user can watch how the data points change over time, which assists the user in determining what is occurring to the sensors.

FIG. 3 is a diagram of an example of an anomaly presentation (300) according to the principles described herein. The anomaly presentation (300) displays just relevant information about anomalies found in the data points. In this example, the anomaly presentation (300) identifies an anomaly type (302) of no power (304) and identifies affected sensors (306).

In other examples, multiple anomalies are found throughout the data points. In such examples, the anomaly presentation (300) identifies each of the anomalies. In yet other examples, the presentation system generates multiple anomaly presentations dedicated to at least one of the anomalies. In such examples, the user has an ability to switch between the multiple anomaly presentations (300).

FIG. 4 is a diagram of an example of an interpretative presentation (400) according to the principles described herein. The interpretative presentation (400) indentifies which issues are indicative of the anomalies found in the data points. In this example, the interpretative presentation (400) identifies a first anomaly (402) and identifies an issue that is likely based on the anomaly. The interpretative presentation (400) identifies an issue (404) of the sensors in specific regions of the area where the seismic survey is being conducted that appear to be broken.

In some examples, the anomalies indicate more than one possible issue. In such an example, the interpretative presentation (400) lists all of the possible issues, lists just the most likely issues, indicates just the most likely issue, or combinations thereof.

The interpretative presentation (400) may identify more than one anomaly, and accordingly, lists each of the anomalies along with their corresponding issue or issues. In other examples, the presentation system generates multiple interpretative presentations (400) that are dedicated to at least one of the anomalies. In such examples, the user has an ability to switch between the multiple interpretative presentations (400).

In some examples, the interpretative presentation (400) uses historical information to interpret the anomalies. For example, if a sensor is reporting full power for a time duration, and then reports no power, the interpretative presentation (400) will likely interpret the anomaly of no power as an issue where the sensor has been damaged by a sudden environment hazard. On the other hand, if the historical data indicates that the sensor's power level was fluctuating prior to reporting no power, the interpretative presentation (400) may instead interpret this anomaly as a faulty connection.

FIG. 5 is a diagram of an example of a response presentation (500) according to the principles described herein. The response presentation (500) lists recommended responses (502) to the various anomalies found throughout the data points. In this example, the recommended response (502) includes examining (504) the specific regions where the sensors are broken to look for environmental hazards that broke the sensors. In other examples, multiple recommended responses are listed for a single anomaly. Also, more than one anomaly with corresponding recommended responses may be included in a single response presentation (500).

In other examples, the presentation system (500) generates more than one response presentation (500), each of which is dedicated to at least one anomaly. In such examples, the user has an ability to switch between the multiple response presentations (500).

The various presentations allow a user to view different levels of analysis based on the user's interest. Thus, if the user views a response presentation, the user can choose to execute the recommended response without making reference to more information available to him. However, the user may desire to dig deeper into the information obtained from the sensors to understand why the presentation system is making the identified recommended responses. However, some users can be overwhelmed by viewing all of the information in the data point presentation. As a result, the presentation system provides other presentations that assist the user by making connections between data points, highlighting relevant subsets of data points, interpreting the meaning of those relevant subsets of data points, and making recommendations based on those interpretations. Thus, the user may view each level of analysis that the user desires before making a decision or confirming that a made decision is sufficient.

While the examples above have been described with reference to specific types of presentations any type of presentation may be generated according to the principles described herein. For example, the presentations do not have to be centered around anomalies found throughout the data points. For example, the presentations may include other types of presentations that allow a user to determine when maintenance should be applied to a system, to make go/no go decisions in executing a project, how to execute a project, other tasks, or combinations thereof.

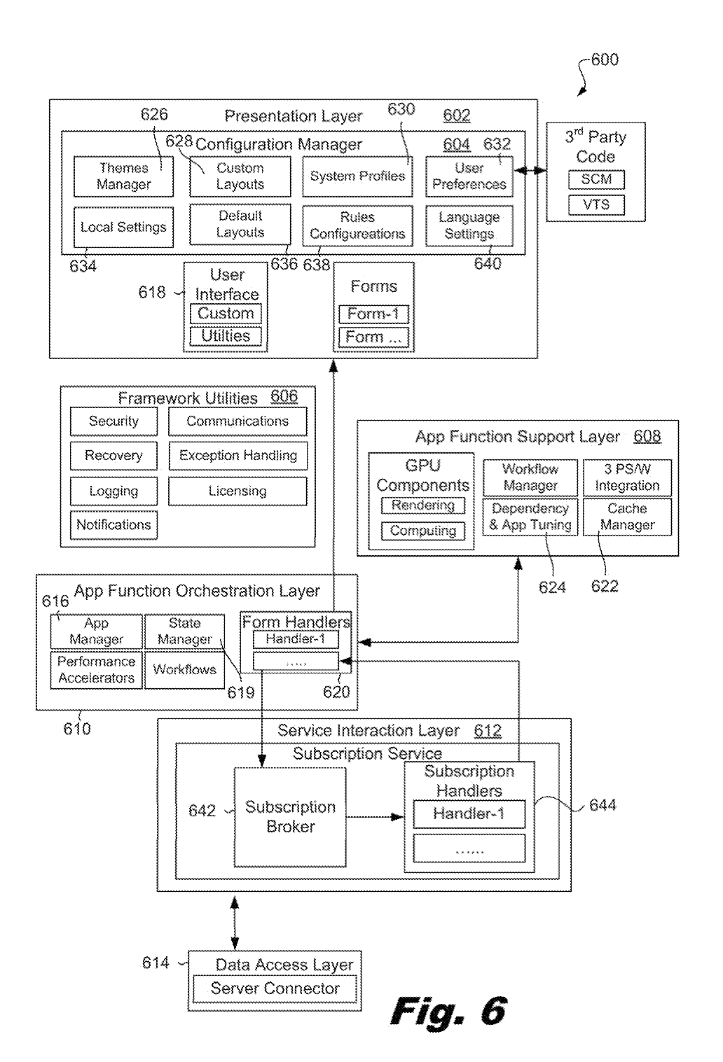

FIG. 6 is a diagram of an example of a presentation system's architecture (600) according to the principles described herein. In this example, the architecture (600) includes a presentation layer (602), a configuration manager (604), a framework utility (606), an application function support layer (608), an application function orchestration layer (610), a service interaction layer (612), and a data access layer (614). While this example is described with reference to specific architectural components, any appropriate architectural components and/or arrangement of architectural components may be used in accordance with the principles described herein.

The application function orchestration layer (610) provides the infrastructure to support the presentation layer (602) of the presentation system, which can be scaled up or down based on the number of sensors and the state of the network in the seismic survey or other systems utilizing the sensors. The application function orchestration layer (610) provides the facility to do centralized management of shared resources and controls the state and flow of various elements of the presentation layer (602). Automation of certain tasks to provide multiple presentations of significant events can be applied to various sub-systems and third party applications used in the seismic survey or other system(s).

An application manager (616) of the application function orchestration layer (610) is the entry point into the presentation system. The application manager (616) initializes the user interface (618) and resources on an application startup program. The application manager (616) also provides methods for restarting or exiting the presentation system.

A state manager (619) of the application function orchestration layer (610) maintains the active state of messages, subscriptions, sessions, and user interface states, and settings for multiple users. These states apply when the network is down, when a form is reopened, and/or when an action is called by the form handlers for any appropriate interaction with the service interaction layer (612).

Form Handlers (620) of the application function orchestration layer (610) process the non-user interface rendering logic. The services of the form handlers (620) are requested by user interface forms and other control events programs.

The application function support layer (608) provides the core infrastructure to manage the performance parameters for real time analytics. A cache manager (622) of the application function support layer (608) manages the cache for the ever changing state of the presentation system. A dependency manager (624) of the application function support layer (608) conducts application start up checks for hardware dependencies, system configurations, and third party configurations. The dependency manager (624) also conducts active monitoring of the dependencies needed to keep the program functioning.

The presentation layer (602) initializes the user interface during an application startup. The user interface manager loads user privileges, brings up the user interface for logged in users, and collaborates with other managers to manage user interface events, interactions, and orchestrations. The presentation layer (602) includes a configuration manager (604), a themes manager (626), a custom layout manager (628), a system profile manager (630), a user preference manager (632), a local settings manager (634), a default layout manager (636), a rules configuration manager (638), a language setting manager (640), other managers, or combinations thereof.

The service interaction layer (612) has a subscription broker (642) that initializes subscription handlers (644), routes subscription requests to the subscription handlers (644) and/or message handles based on the subscription identifiers, routes un-subscription requests to the subscription handlers (644) based on subscription types, and notifies the state manager (619) to manage the presentation system. The subscription handlers (644) initialize resources to handle associated subscriptions and execute publishing tasks for subscribers. Message Handlers initialize resources to handle associated messages and execute commands for the messages.

The data access layer (614) is an intermediate component between the server and the client. The data access layer (614) handles requests from the service interaction layer (612) and delivers them to the server, receives responses from the server, and passes the responses back to the appropriate source. The framework utilities (606) span the entire architecture and provide utilities for security, licensing, exception handling, logging, notification, other services, and combinations thereof.

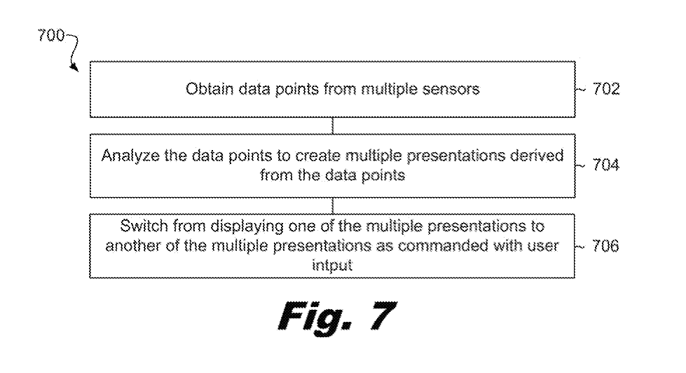

FIG. 7 is a diagram of an example of a method (700) for presenting information from multiple sensors according to the principles described herein. In this example, the method (700) includes obtaining (702) data points from multiple sensors, analyzing (704) the data points to create multiple presentations derived from the data points, and switching (706) from displaying one of the multiple presentations to another of the multiple presentations as commanded with user input.

In some examples, the sensors are wireless sensors that are positioned throughout an area. The area may be a surface area superjacent a subterranean formation of interest, and the sensors may be geophysical survey sensors, such as seismic sensors.

The multiple data points are real time data points. The data points may be received with the presentation system on a periodic basis that is one minute or less.

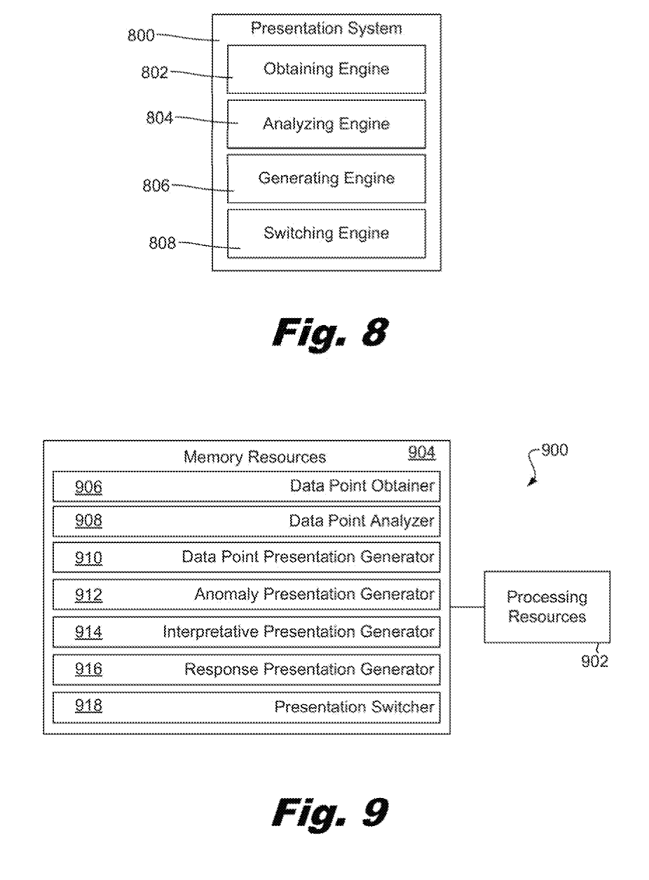

FIG. 8 is a diagram of an example of a presentation system (800) according to the principles described herein. In this example, the presentation system (800) includes an obtaining engine (802), an analyzing engine (804), a generating engine (806), and a switching engine (808). The engines (802, 804, 806, 808) refer to a combination of hardware and program instructions to perform a designated function. Each of the engines (802, 804, 806, 808) may include a processor and a memory. The program instructions are stored in the memory and cause the processor to execute the designated function of the engine.

The obtaining engine (802) obtains the data points from the sensors. In some examples, the obtaining engine (802) obtains the data points by requesting the data points. In other examples, the obtaining engine (802) obtains the data points automatically sent from the sensors. The obtaining engine (802) may include hardware for receiving wireless data signals, hardware for signals sent over at least a hardwired connection, or combinations thereof. In other examples, the data points from the sensors are first collected in a data base or a storage mechanism, and the obtaining engine (802) receives the data points from the database or a storage mechanism.

The analyzing engine (804) analyzes the data, and the generating engine (806) uses the analysis to create at least two presentations based on the data points. The switching engine (808) allows the user to switch between the presentations as desired.

FIG. 9 is a diagram of an example of a presentation system (900) according to the principles described herein. In this example, the presentation system (900) includes processing resources (902) that are in communication with memory resources (904). Processing resources (902) include at least one processor and other resources used to process programmed instructions. The memory resources (904) represent generally any memory capable of storing data such as programmed instructions or data structures used by the presentation system (900). The programmed instructions shown stored in the memory resources (904) include a data point obtainer (906), a data point analyzer (908), a data point presentation generator (910), an anomaly presentation generator (912), an interpretative presentation generator (914), a response presentation generator (916), and a presentation switcher (918).

The memory resources (904) include a computer readable storage medium that contains computer readable program code to cause tasks to be executed by the processing resources (902). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, or other types of memory, or combinations thereof.

The data point obtainer (906) represents programmed instructions that, when executed, cause the processing resources (902) to obtain data points from the sensors. The data point analyzer (908) represents programmed instructions that, when executed, cause the processing resources (902) to analyze the data points.

The data point presentation generator (910) represents programmed instructions that, when executed, cause the processing resources (902) to generate a data point presentation that displays the data points obtained from the sensors. The anomaly presentation generator (912) represents programmed instructions that, when executed, cause the processing resources (902) to generate an anomaly presentation that displays the data points relevant to anomalous behavior of the sensors. The interpretative presentation generator (914) represents programmed instructions that, when executed, cause the processing resources (902) to generate an interpretative presentation that displays an interpretation of which issues the anomalous data points indicate. The response presentation generator (916) represents programmed instructions that, when executed, cause the processing resources (902) to generate a response presentation that displays recommended responses of how the user should respond to the anomalous data points. The presentation switcher (918) represents programmed instructions that, when executed, cause the processing resources (902) to switch between the different presentations generated with the presentation system (900) in a display.

Further, the memory resources (904) may be part of an installation package. In response to installing the installation package, the programmed instructions of the memory resources (904) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (902) and the memory resources (904) are located within the same physical component, such as a server, or a network component. The memory resources (904) may be part of the physical component's main memory, caches, registers, non-volatile memory, or elsewhere in the physical component's memory hierarchy. Alternatively, the memory resources (904) may be in communication with the processing resources (902) over a network. Further, the data structures, such as the libraries, may be accessed from a remote location over a network connection while the programmed instructions are located locally. Thus, the presentation system (900) may be implemented on a user device, on a server, on a collection of servers, or combinations thereof.

The presentation system (900) of FIG. 9 may be part of a general purpose computer. However, in alternative examples, the presentation system (900) is part of an application specific integrated circuit.

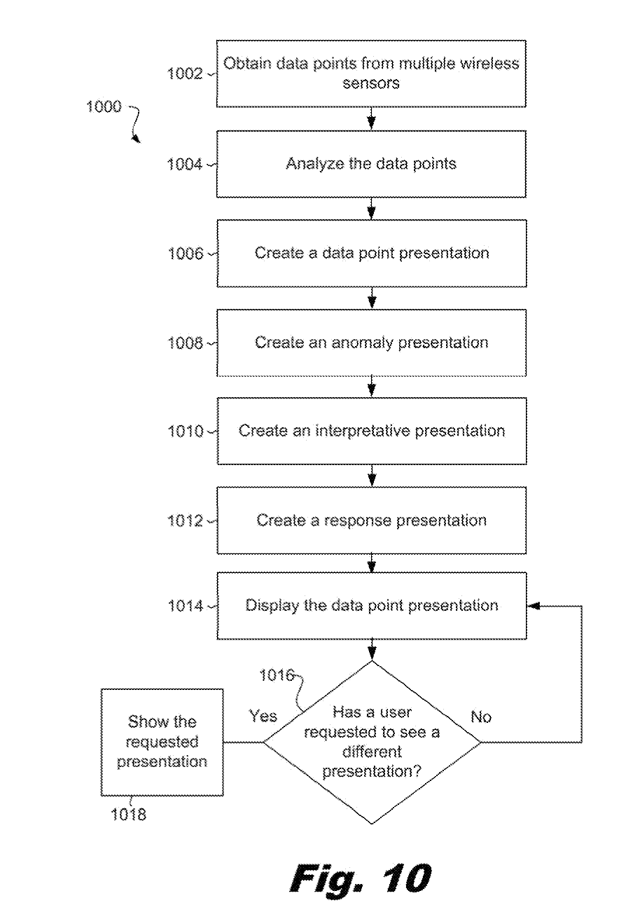

FIG. 10 is a diagram of an example of a flowchart (1000) of a process for presenting information from multiple sensors according to the principles described herein. In this example, the process includes obtaining (1002) data points from multiple wireless sensors and analyzing (1004) the data points. Based on the data points and the corresponding analysis, the process includes generating (1006) a data point presentation, generating (1008) an anomaly presentation, generating (1010) an interpretative presentation, and a generating (1012) a response presentation. The data point presentation is displayed (1014) in a display.

The process includes determining (1016) whether the user has requested to see a different presentation. If not, the data point presentation is continued to be displayed (1014). However, if the user has requested to see a different presentation, then the process includes displaying (1018) the requested presentation.

While the examples above have been described with reference to specific sensors and implementations of sensors, any appropriate sensor or implementation of the sensors may be used in accordance with the principles described herein. For example, the sensors may be geophysical sensors, wireless sensors, network sensors, hardwired sensors, electronic sensors, electric sensors, magnetic sensors, gravity sensors, thermal sensors, hardness sensors, pressure sensors, other sensors, or combinations thereof. Also, the sensors may be incorporated into any appropriate system, such as seismic surveys, machinery, vehicles, aircraft, watercraft, building, computers, other systems, or combinations thereof.

While the examples above have been described with reference to specific presentations and types of information displayed in such presentations, any appropriate presentation may be generated and any appropriate type of information may be displayed in accordance with the principles described herein. Further, while the examples above have been described with reference to specific mechanisms for switching between the presentations, any appropriate mechanism for switching between the presentations may be used. Also, while the above examples have been described with reference to specific decisions that a user can make in response to the presentations, any appropriate decisions can be made by the user. The user is not bound to make decisions in accordance with the recommendations made by the presentation system. The user can make independent decisions based on the information presented in the other presentations.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for presenting information from multiple sensors, comprising:
obtaining data points from multiple seismic sensors in a seismic survey;
analyzing said data points to create multiple presentations about said seismic survey; and
switching from displaying one of said multiple presentations to another of said multiple presentations as commanded with user input.

2. The method of claim 1, wherein said multiple presentations convey different levels of analysis based on said data points from said seismic survey.

3. The method of claim 1, wherein said multiple presentations include a data point presentation that displays said data points.

4. The method of claim 1, wherein said multiple presentations include an anomaly presentation that displays anomalies derived from said data points.

5. The method of claim 1, wherein said multiple presentations include an interpretative presentation that displays interpretative conclusions of anomalies derived from said data points.

6. The method of claim 1, wherein said multiple presentations include a response presentation that displays recommendation responses to anomalies derived from said data points.

7. The method of claim 1, wherein said multiple data points are real time data points.

8. The method of claim 1, wherein obtaining said data points from said multiple sensors includes receiving said data points on a periodic basis that is one minute or less.

9. The method of claim 1, wherein said multiple sensors are wireless sensors positioned throughout an area.

10. A system for presenting information from multiple sensors, comprising:
an obtaining engine to obtain data points from multiple sensors of a seismic survey;
an analyzing engine to analyze said data points;
a presentation generating engine to create multiple presentations derived from said data points based on different levels of analysis; and
a switching engine to switch from displaying one of said multiple presentations to another of said multiple presentations as commanded with user input.

11. The system of claim 10, wherein said obtaining engine obtains said data points on a periodic basis that is one minute or less.

12. The system of claim 10, wherein said multiple sensors are geophysical survey sensors.

13. The system of claim 10, wherein said multiple presentations includes a data point presentation, an anomaly presentation, an interpretative presentation, and a response presentation, or combinations thereof.

14. A computer program product for presenting information from multiple sensors, comprising:
a non-transitory computer readable storage medium, said non-transitory computer readable storage medium comprising computer readable program code embodied therewith, said computer readable program code comprising program instructions that, when executed, causes a processor to:
receive data points from multiple sensors on a periodic basis from a geophysical survey;
analyze said data points in real time;
generate multiple presentations derived from said data points about said geophysical survey;
display at least one of said multiple presentations; and
switch from displaying said one of said multiple presentations to another of said multiple presentations as commanded with user input.

15. The computer program product of claim 14, wherein said multiple sensors are wireless geophysical survey sensors positioned throughout an area.
